(19) United States
(12) Patent Application Publication
(10) Pub. No.: US 2019/0149785 A1
(43) Pub. Date: May 16, 2019

(54) Novel Artistic Display and Method of Display

(71) Applicant: Aaron Munk, Lakewood, NJ (US)

(72) Inventor: Aaron Munk, Lakewood, NJ (US)

(21) Appl. No.: 15/978,428

(22) Filed: May 14, 2018

Related U.S. Application Data
(60) Provisional application No. 62/506,066, filed on May 15, 2017.

(51) Int. Cl. H04N 9/31; B44F 1/06

(52) U.S. Cl. CPC H04N 9/3179; H04N 5/23229; B44F 1/06

(57) ABSTRACT

An artistic display system and method of using the system is provided whereby the system includes a display stone, a parallel art object, an image capture device, and an image display device, wherein said parallel art object is displayed on said image display stone.

### BACKGROUND OF THE INVENTION

One of the oldest forms of expression known to mankind is that of visual art. From the earliest of cave paintings until today, mankind has continued to evolve and contribute to personal expression through artistic creation. There are numerous techniques that have accompanied recent technological advancements in the visual arts. The present invention sets forth a novel visual art display and method of creating the display that until now has yet to come into existence.

### SUMMARY OF THE INVENTION

This invention relates to what may or may not be referred to in the art world as a form of “immersive art”, utilizing one or more forms of mixed media to tell a story that a creative artist sees in nature, typically on a flat surface of natural stone.

This is accomplished by displaying a carefully chosen slab of stone. In one embodiment, strategically placed within the proximity of the stone, can be an artist's rendering of what the accentual art visionary sees in the stone.

This “secondary” art is the means by which the artist/user assists the viewer at seeing the art and “the story” that the visionary has seen in the stone.

Lighting is manipulated on the stone to accentuate the veins that make up the art scene that is difficult to perceive without the aid of light and projection of the secondary man-made artwork on to the stone (or viewing) surface. The light reflected/projected on the stone is, at first, typically at zero power. Over a period of time it comes to full power, accentuating the art scene the artist found within the stone. After the light transitions back to zero, the imagery it still “seen” in the natural stone.

Taking the lighting aspect to the next level, (in another embodiment) the lighting can also be presented as an animation, which weaves “the story” on the stone in a motion animated format that can include a sound element as well.

The general steps needed to create an Accentual Art set are:

1. Exploratory Stage

2. Slab Identification

3. Rough Scene Mapping

4. Stone Cutting, Polishing and Installation

5. Fine Scene Mapping

6. Secondary Art Creation

7. Art AccentMapping

8. Stone AccentMapping

9. Hybrid AccentMapping

10. Cinematic Animation

11. Optional Secondary Art Strategic Placement and Lighting

As mentioned earlier, the process entails multiple phases. The following is a description of the step-by-step process. While the process can apply to any natural substance, we will explain it using stone as the example:

1. Exploratory Stage

The first step is exploring the natural medium that will be the foundation of the art. The medium can be stone (granite, onyx, marble, quartzite, limestone, soapstone, travertine etc.) or any natural medium, including but not limited to wood and animal hide.

Stone yards, quarries and any place where unmolested natural surfaces are present, are thoroughly canvassed by the artist. He/she searches for surfaces, material and objects that exhibit beauty, potential art scenes, as well as a practical ability to accentuate and display. The search process may include lighting it from the front to help visualize the hidden art. For onyx or stones that are partially transparent, back lighting is a key factor as the veins that are translucent can often be seen only when lit. Certain semi-transparent stones will be displayed with one or more form of backlighting and therefore backlighting it prior to selection can be an essential component.

Being that most of the time the art scene will not necessarily be displayed in the orientation first displayed on the yard floor, each potential slab is photographed and later studied in at least 4 positions—as displayed on the floor, at 90, 180 and 270 degree rotations.

If the art scene is at an angle that is not at a perfect 90, 180, 270 or 360 degrees, the slab will be recut at a rectangle, so long as the art scene is small enough to be cut at an angle within the confines of the slab. As such, art scenes can be identified even at an angle that is not at a perfect 90, 180 or 270 degree orientation. Additionally, certain works will call for the slab to be cut to a more natural looking non-linear and rough edge. This too allows for the art orientation to be at virtually any angle.

When a slab seems to have potential, it can be studied in depth, and importantly, at various angles by reclining sideways. Squinting, VR glasses and wearing glasses that are tinted with various colors also assists in having the art scene “jump” out and will assist later in the process, of creating the light mapping with the correct color overlays to highlight the accentuation.

2. Slab Identification

While exploring the slabs, a numbering system is utilized to filter out the slabs which can best be applied for accentual art. The numbering process takes into account; a) the stone's aesthetic beauty, independent of the lighting and secondary art, b) the beauty of the perceivable art scene and c) the obviousness of said scene.

The slab and its ID markings or label is photographed, and then recorded by location, slab name, and slab ID. It is then given 3 numbers, recorded as x/y/z. The first number represents the beauty of what the researcher feels the slab exhibits, independent of any art scene it might display. This is recorded on a scale of 1-10, with 10 being the most visually pleasing. The second number represents the artistic quality of an art scene the accentual art visionary feels the slab may contain. This, too, is numbered 1-10, with 10 being the most visually recognizable. The third number represents the obviousness of the perceived scene to the extent that it can be identified even when the ALMA™ lighting fades. 1

3. Rough Scene Mapping

All slabs being considered (likely 9/9/9s and higher) are photographed. Slabs deemed to have the greatest potential are printed and a rough sketch of the art scene envisioned is drawn on top of the printout. Once modified and deemed worthy, a slab is purchased.

4. Stone Cutting, Polishing, Preparation and Installation

Depending on the art scene size, angle and location on the stone, the slab is cut to a size that best captures and centers the art scene. In some instances, specialty edging is executed.

Polishing can be applied, based on the stone's vibrancy, reflective nature, and artistic makeup. In certain cases, other preparatory methods can be applied to the stone, including but not limited to painting, etching, carving, chiseling, engraving, sculpting, fusing other materials onto the main display surface including but not limited to other stones, glass etc., detailed scorching using (fire, heat, laser or any other known means)

Depending on the size and weight of the slab, a frame may be created for display. This can be on a frame that can stand alone, or it can be displayed on a wall, likely by being fastened to existing beams.

When using stones that can be backlit, including but not limited to onyx, the slab will be displayed in front of a monitor or other lighting apparatus that will allow for the portrayal of specific art scenes to be seen by targeted lighting of specific veins found within the stone, thereby allowing the viewer to perceive the art from the front of the stone, while the lighting apparatus is behind the stone.

The lighting device can be set into a wall or the frame can be built in a way that can accommodate it. The slab is then delivered and installed in a studio in preparation for the Accent Mapping lighting phases.

5. Fine Scene Mapping

Once in the studio, the slab is photographed professionally and one digital version is chosen as the “base” image. All future work utilizes this image as the base. The digital image is projected onto a cotton, linen, synthetic or aluminum blank canvas. The first rough sketch is executed when the canvas is illuminated at full strength. An artist, in conjunction with the accentual art visionary, outlines a rough version of the art scene on the canvas using paint and/or any other medium seen fit by overlaying the image of the slab being projected on the canvas with the art scene envisioned. Keeping the art true to the slab's veins and composition is the focus at this stage.

6. Secondary Art Creation

Once the raw sketch is complete, the projection is lowered to half power and the rough sketch is overpainted with a focus on its artistic quality, while keeping as true as possible to the stone's composition.

Finally, the projection is lowered to being nearly invisible and the art is completed to perfection. The abstract elements on the slab can be creatively woven into the art scene.

When a sculpture is chosen as the secondary art, instead of a painting, the sculpting is done with a large picture of the mapped canvas layered onto the projection in close proximity so that the sculptor can mimic the intended scene.

7. Art Accent Mapping

The completed secondary art is then photographed. The outline of the elements and/or subjects that correlate to the stone are then “lifted” and separated using advanced photo editing and manipulation software. The first level of selection can be made using software including but not limited to Photoshop, by utilizing advanced selection tools. An example may be via the Color Range tool within the Select function and adjusting the functions, depending on the image. Functions include Localized Color Clusters using the Selection option and adjusting the Fuzziness and Range accordingly. Fine-tuning the selection can be used via a wide array of functions and tools, or manually, and can be further systematized utilizing automated Batch processing or “Macros”.

Any part of the scene which is not artistically considered a “subject” can be made translucent or turned to pure white.

8. Stone Accent Mapping

Once again using digital photographs of the completed secondary art, another version of the art scene is created but this time, showing the original stone's veins that compose the scene. As opposed to the previous step which creates a digital file that shows a detailed colored painting of the art's subjects against a fully transparent or white background, this version shows an almost identical outline of the art's subjects against a fully transparent or white background, but this version shows the stone's original veins and, importantly, is 100% true to the stone's original composition.

This is accomplished by using the slab as a monitor via Extended Display. In order for this to be accomplished, the projector is adjusted to be illuminated exactly over the slab and the following resolutions must match exactly so as to utilize the slab as a “live” digital canvas: a) projector resolution, b) media player resolution, c) movie rendering software resolution when applicable and d) image rendering software resolution as demonstrated in FIG. 12.

(To illustrate, if one was to layer the two versions on top of each other, both would have almost identical outlines, but the first would; a) show a detailed artistic rendering that is truer to a real life painting, and, b) its outline would be artistically accurate. The second would have an almost identical outline but would; a) show the stone's composition and, b) the outline of this version would follow accurately the stone's veins and not necessarily be 100% artistically accurate. (See appendix for illustration.)

9. Hybrid Accent Mapping

Using digital photo manipulation software, the two images mentioned above (the Art Accent Mapping version and the Stone Accent Mapping version) are layered atop each other and the opacity of the top layer is lowered so that both can be seen. The Art Accent Mapping layer's outline is modified to match the exact outline of the Stone Accent Mapping layer.

Additionally, any elements that are on the original unmolested stone is removed. The intent is to minimize the projected image and use as much of the stone's natural composition instead.

Once the outline of the Art layer is modified, it is projected onto the slab. The art's subject should be seen within the stone's composition, and sections of the stone that are not illuminated should complement perfectly with the art. The edges and outline of the stone should match and accentuate the art perfectly.

Vibrancy can be digitally added to the image and the hue, brightness, contrast and other effects are modified to blend in—yet accentuate the art scene—when projected on the stone. It is essential that as much of the stone's original composition is used and that the projection serves to hint at the scene without overpowering the stone with imagery. The point is for the projection and the stone to complement each other and together, show the art envisioned.

Once complete, the image is projected onto the stone potentially using a high-lumens projector with an ultra-short throw lens positioned higher than the stone to minimize glare when viewed head on.

The file is imported to a movie-making software and added as a second file. The first file is pure white (or, in some cases, black).

A cross-fade transition is placed between the two files and at the start of the first file and they are set to loop continuously.

When first observed, the slab is seen without overlaid imagery and is illuminated by the white file from the projector. Slowly, the art comes to life and “pops” out of the stone, eventually becoming clear when at full power. It stays at full power for a while and then transitions out slowly until the overlay disappears entirely. This can be accompanied with audio that

Once exposed to the overlay, the viewer will still be able to see the art even when the projected overlay disappears completely, due to the stone's visual composition that was chosen to show the scene. The continuously looping transition of the overlay, along with the optional secondary art, assists the viewer in seeing the accentuated art and allows the viewers to expand their own interpretation and see their own version of the story. This projection setting is called the “transition to full” or “Simple Fade In/Fade Out Version”.

Depending on the art and stone, other lighting techniques, including lasers, precision lighting, as well as backlighting for onyx and other translucent material, can be utilized.

The result is a unique blend of a projected image that both overlays and complements the original stone's composition, merging light and stone in a way that completes an impressive artistic rendering. The blend of the stone's outlines, coupled with the semi-transparent accents of the art image overlay, result in a newly perceived image that embodies the ALMA experience.

10. Cinematic Animation

Taking the concept a step further, the imagery can be expanded to include motion.

The art typically found in stone has “drama” and “movement” as well. When drama and movement is sensed by the artist, an animation version of the art scene, utilizing the entire slab as the backdrop, can be created.

Typically utilizing the still art as the base, the animation can utilize parts of the stone, the secondary art, or completely separate elements, so long as it “fits”. If included in the display, the animation can include illuminating and spotlighting parts of the secondary art as well.

Typically, the animation's “story” precedes the secondary art scene, and the crescendo peaks with the final art scene on full display and then fades to best emphasize how the static art scene, also known as the “petrified scene”, is actually culled from the stone

Audio is typically added and can either be purchased or created specifically for the piece.

While the art is usually shown in the silent “transition to full” format, a viewer can choose to view the animated version by controlling the files via a programmable remote control that would override the “transition to full” file and replace it with the animated/audio file. Once the full animation is shown, the “transition to full” continues looping.

In one embodiment, the present invention is a visual display system comprising of : at least one stone display;

at least one parallel art object, at least one image capture device, constructed and arranged to capture an image of said at least one parallel art object;

at least one computer processing device and software to design and create and blend said image of the parallel art object in such way as to be integrated with image perceived by artist in said stone and thereby creating said innovative “new” art visual display;

at least one image display device operatively associated with said image capture device and/or associated with a computer file configured to display an image, whereby said image display device is constructed and arranged to display an image on said stone display.

Display, as understood herein means any visual projector and is further contemplated as including, but not limited to laser/LED/targeted lighting, including backlighting, when using a translucent stone (which is not necessarily directly throwingan image onto the viewing surface).

In one embodiment, the stone display is selected from granite or onyx. Selection of said stone is based upon a conceived art scene perceived in the stone. Although granite and stone are commonly used, any stone, wood, or natural surface is contemplated as being usable in the present invention.

In one embodiment, the stone display has a viewing surface prepared for use in said visual display.

In one embodiment, the stone display has a viewing surface prepared for use in said visual display, said preparation including altering or forming topological features on said viewing surface.

In one embodiment the stone display has a viewing surface untouched and un-manipulated at all.

In one embodiment, the parallel art object is a two dimensional object that is the embodiment of the said perceived art scene perceivable in said stone.

In one embodiment, the parallel art object is a three dimensional object that is the embodiment of the said perceived art scene perceivable in said stone.

In one embodiment, the image capture device is a camera.

In one embodiment, the image capture device captures non-readily discernable components.

In one embodiment, the image capture device is operatively associated with a computer microprocessor constructed and arranged to capture an image from said parallel art object.

In one embodiment, the image display device is operatively associated with said image capture device whereby said image display device is constructed and arranged to display an image onto said display stone. That is to say, the image itself is manipulated in such a way that when displayed on the stone, it perfectly matches up to the natural elements in the stone and together produce the art image.

In one embodiment, the image display device is operatively associated with said image capture device whereby said image display device is constructed and arranged to display an entire image of said parallel art object onto said display stone.

In one embodiment, the image display device is operatively associated with said image capture device whereby said image display device is constructed and arranged to display a user selected portion of an image of said parallel art object onto said display stone.

Also contemplated is a method for displaying an image, said method comprising:
providing a display stone having at least one viewing surface;
providing an optional parallel art object;
providing an image capture device;
capturing an image of said parallel art object with said image capture device;
processing said captured image with a microprocessor outputting said captured image to an image display device;
projecting said output image from said image display device onto the viewing surface of the display stone.

In one embodiment, the method includes an initial analysis of the viewing surface of the display stone whereby the analysis includes information relating to physical and topological features of the display stone that are utilized in determining various aspects of both creating the parallel art abject and in displaying an image from the image display device onto the display stone.

### BRIEF DESCRIPTION OF THE SEVERAL VIEWS OF THE DRAWINGS

The patent or application file contains at least one drawing executed in color. Copies of this patent or patent application publication with color drawings will be provided by the Office upon request and payment of the necessary fee.

FIG. 1 is a graphic display demonstrating a parallel art object and the face of a display stone.

FIG. 2 is a graphic display from FIG. 1 whereby part of a single image from the parallel art object is projected onto the display stone.

FIG. 3 is a graphic display from FIG. 1 whereby a complete single image from the parallel art object is projected onto the display stone.

FIG. 4 is a graphic display from FIG. 1 whereby complete of a single image from the parallel art object is projected onto the display stone.

FIG. 5 is a graphic display from FIG. 1 whereby multiple individual images from the parallel art object is projected onto the display stone.

FIG. 6 is a graphic display from FIG. 1 whereby a complete image of the parallel art object is projected onto the display stone, yet lowered in opacity so that the combination of the stone and the lighting overlay mimics the art object.

FIG. 7 demonstrates preparation of a parallel art object prepared for projection onto a display stone.

FIG. 8 is demonstrative of a parallel art object presented as a sculpture to be projected onto a display stone.

FIG. 9 is a graphic display from FIG. 8 whereby the parallel art object sculpture is lined up with the display stone.

FIG. 10 is demonstrative of a parallel art object sculpture projected onto a display stone with the said parallel art object sculpture in the foreground.

FIG. 11 is a chart demonstrating steps of the display and method of the present invention.

FIG. 12 is a flow chart demonstrative of steps in one embodiment of the present invention regarding the resolution matching that is required to make the slab a “live” monitor.

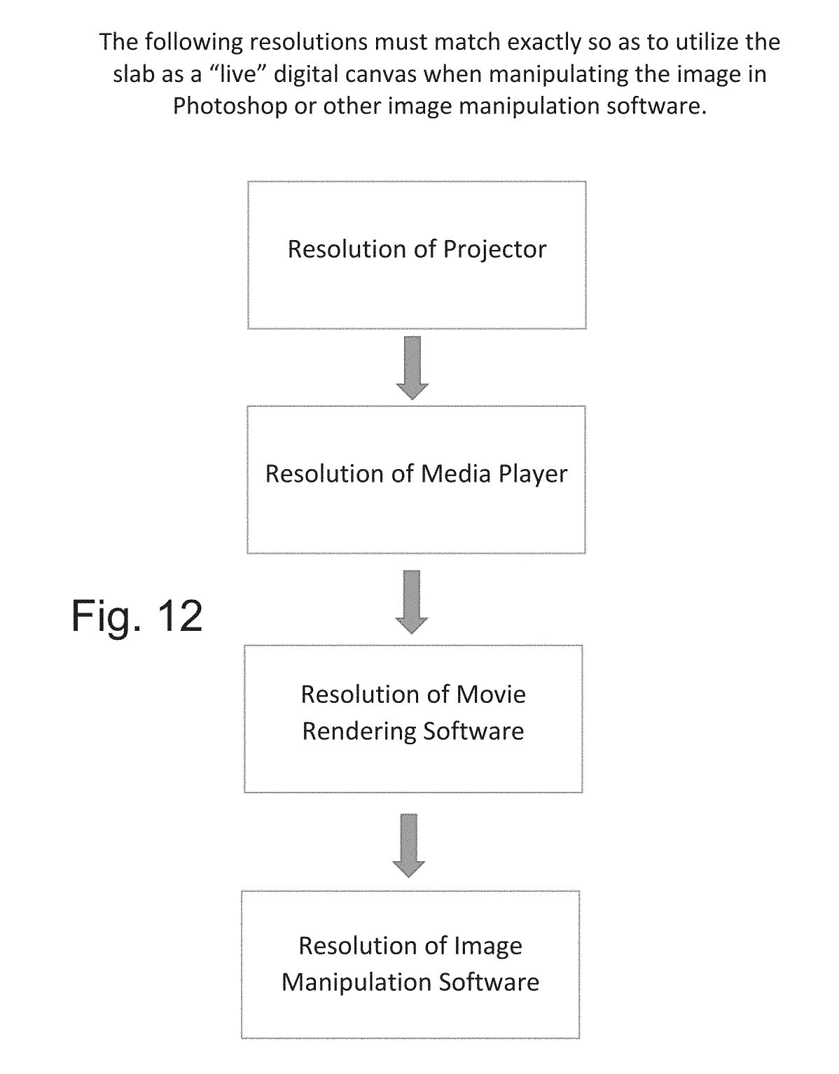

FIG. 13 is a flow chart demonstrative of steps in relation to components, in one embodiment of the present invention.

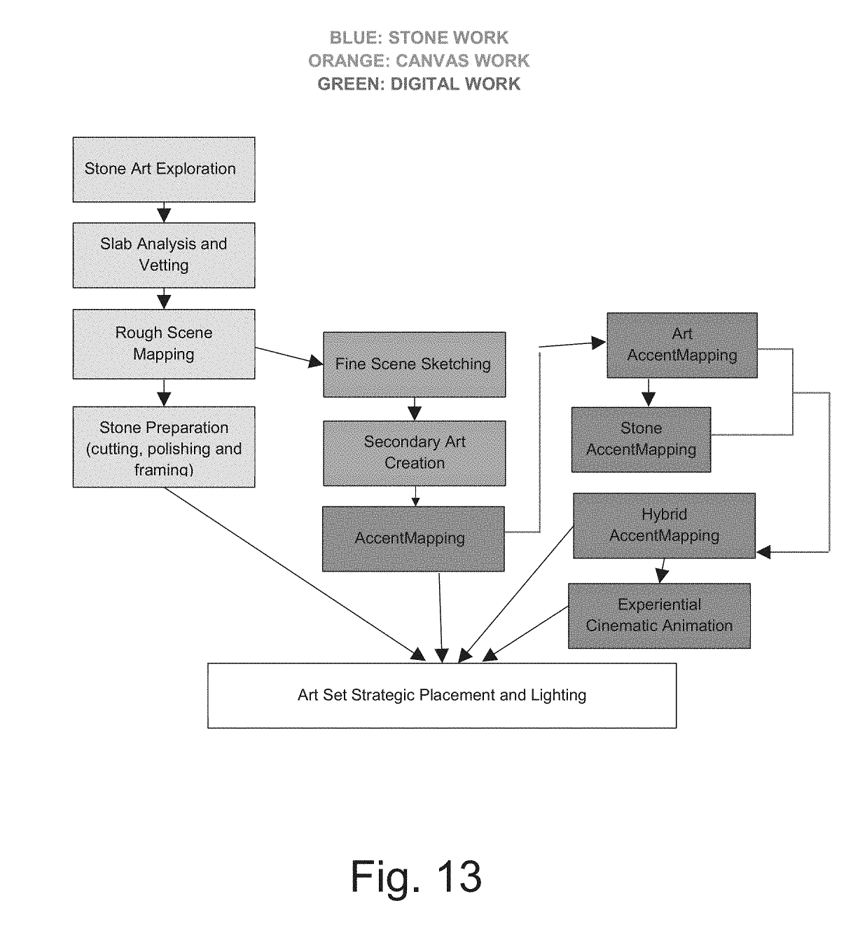

### DETAILED DESCRIPTION OF THE PREFERRED EMBODIMENT

The present invention relates to a novel display and a method of creating the novel display.

A display stone 10 is positioned as desired for persons to view display stone 10. Although the drawings accompanying this disclosure relates to a single parallel art object, it is contemplated that in one embodiment, there is a single parallel art object and a single display.

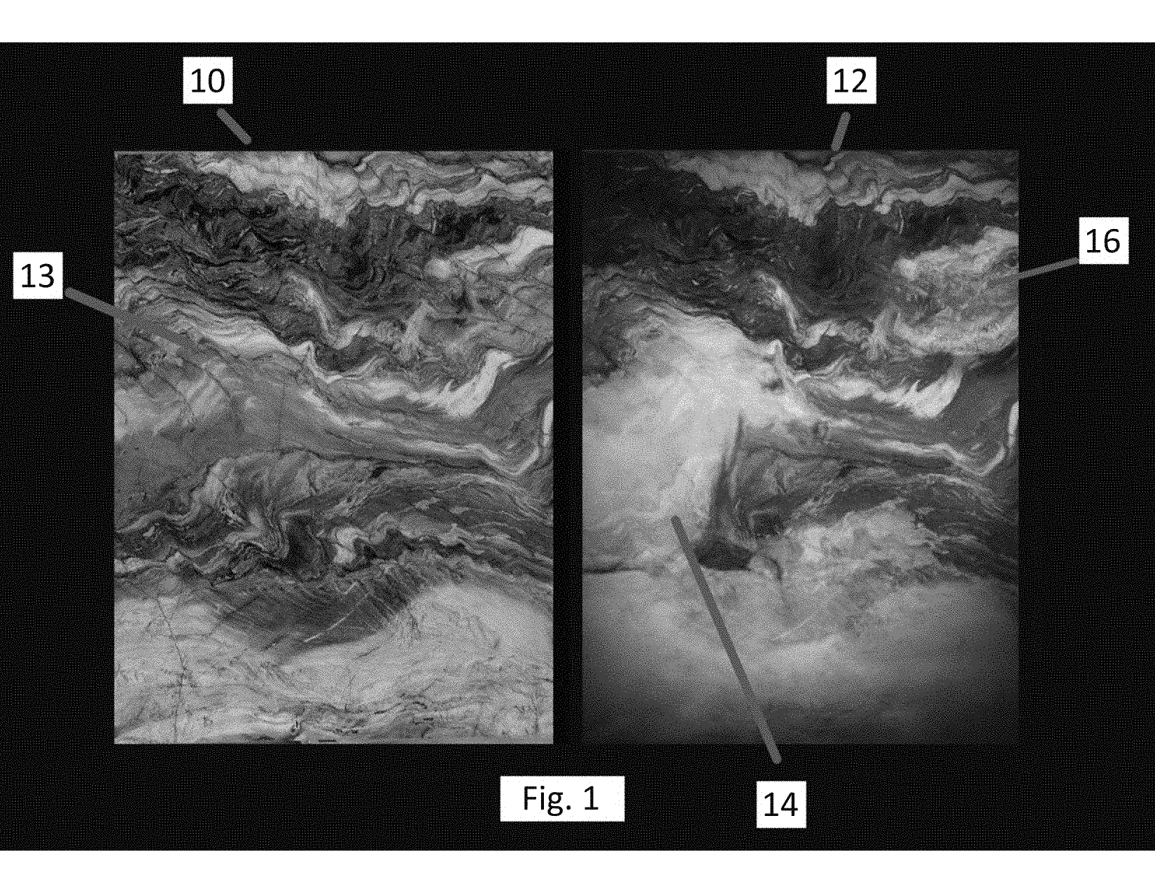

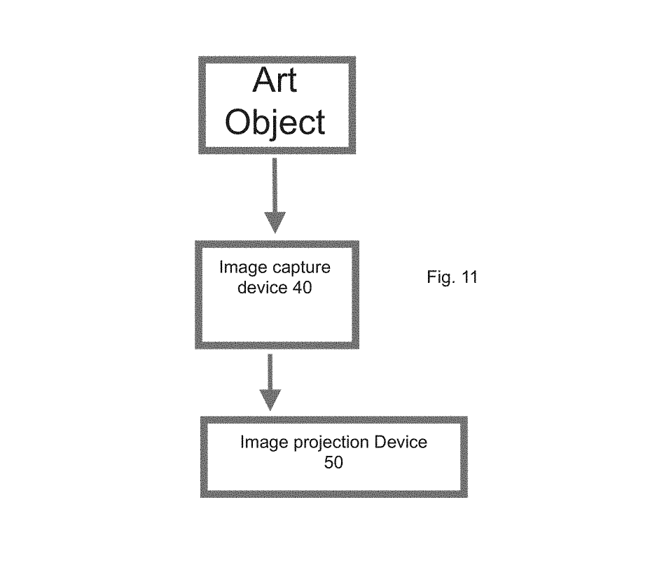

In another embodiment, there are multiple parallel objects that are projected onto one or more display stones. In the embodiment demonstrated in FIGS. 1-5, and 11, parallel art object 12 has a first image 14 and a second image 16 displayed thereon.

An image capture device 40 is constructed and arranged to selectively electronically capture an image from parallel object 12. A user can select the entirety of parallel art object 12, or a particularized portion.

Image capture device 40 is operatively associated with a computer microprocessor which is further associated with image projection device 50.

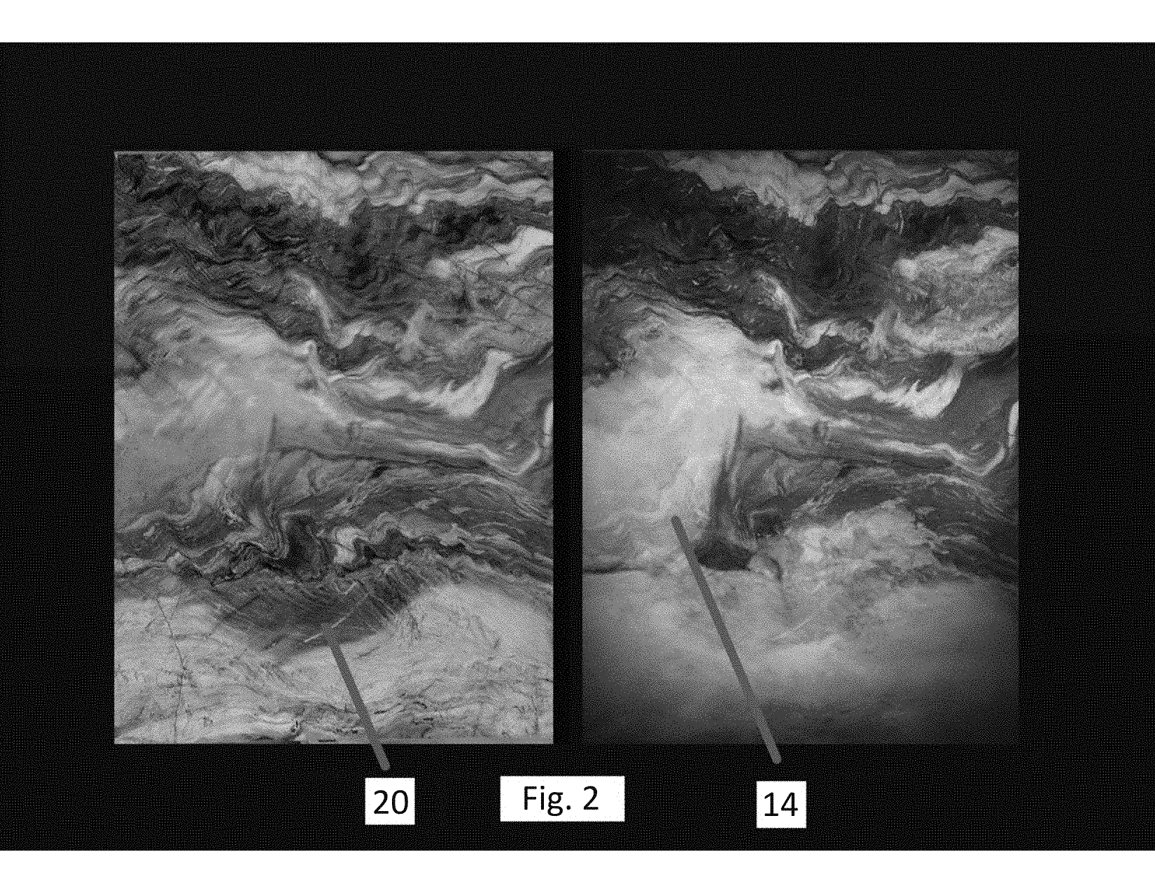

In one embodiment, as demonstrated in FIG. 2 second image 16 is captured utilizing image capture device 40 and a portion of this image becomes display image 20 projected onto display stone 10.

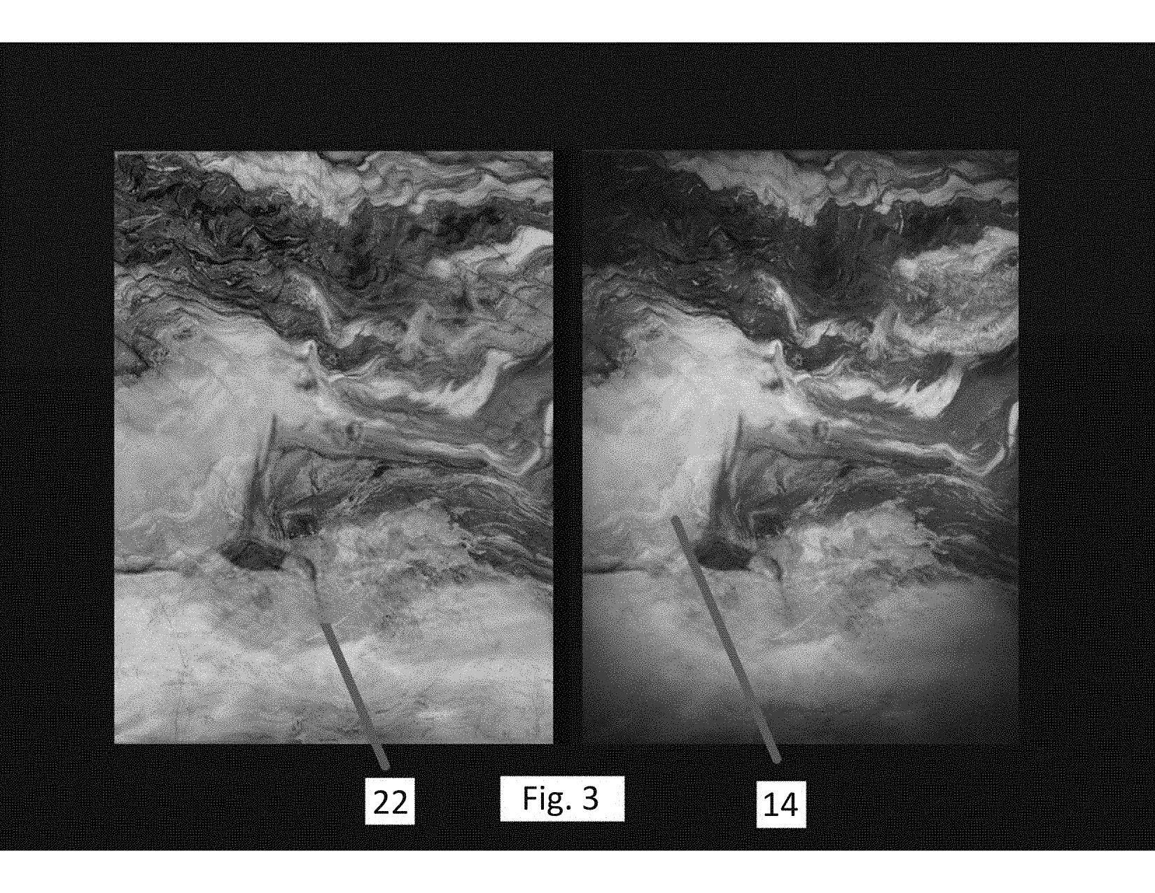

In another embodiment, as demonstrated in FIG. 3, second image 16 is captured utilizing image capture device 40 and a more complete image of second image 16 becomes display image 22 projected onto display stone 10 having at least one display surface 13.

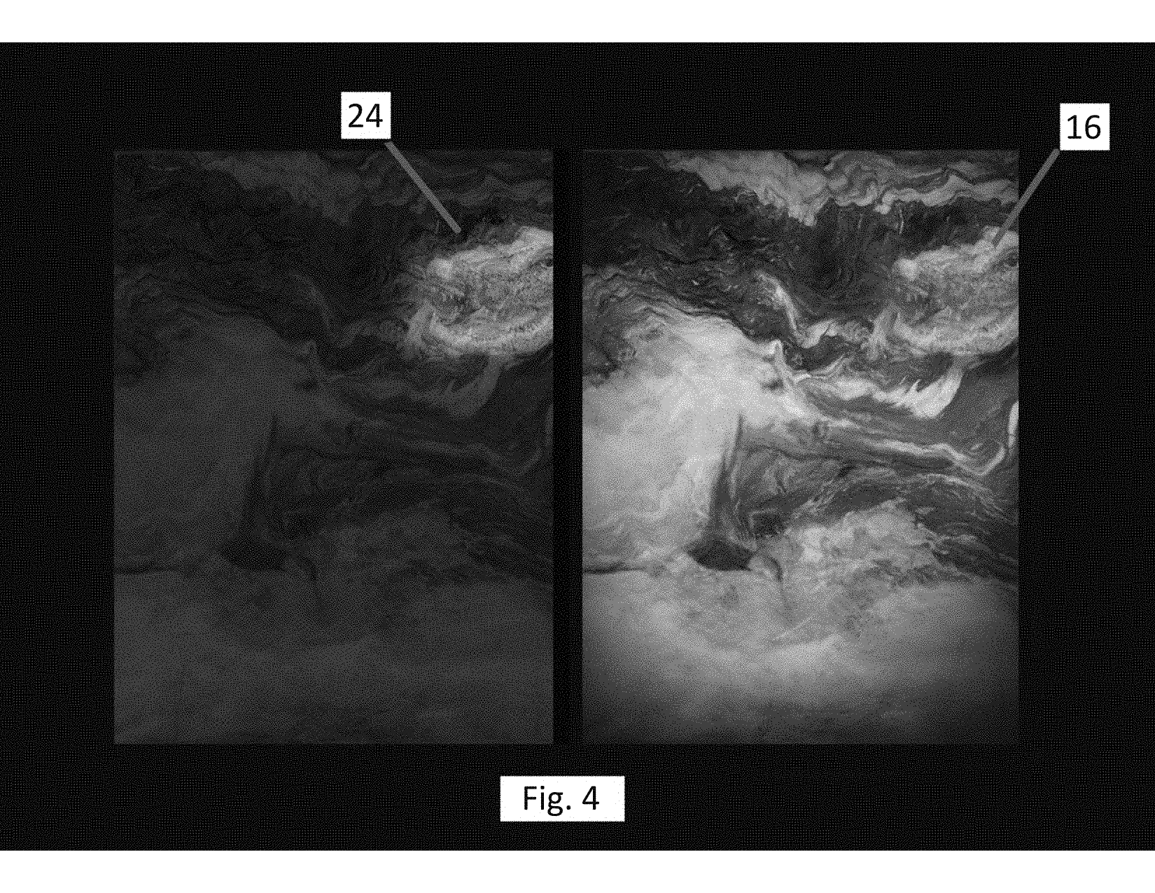

In another embodiment, as demonstrated in FIG. 4, first image 14 is captured utilizing image capture device 40 and becomes image display 24 projected onto display stone 10.

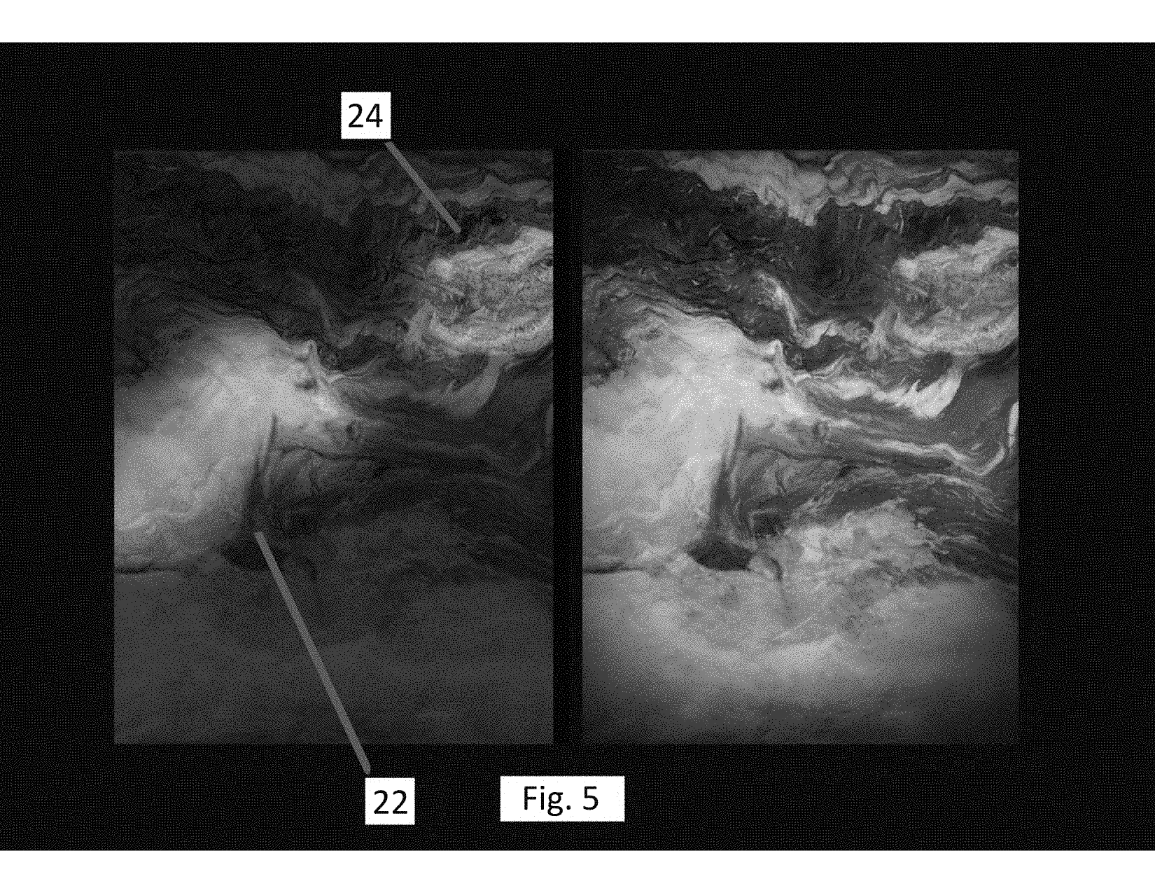

In another embodiment, as demonstrated in FIG. 5, each of first image 14 and second image 16 are captured and the images without background are projected onto display stone 10.

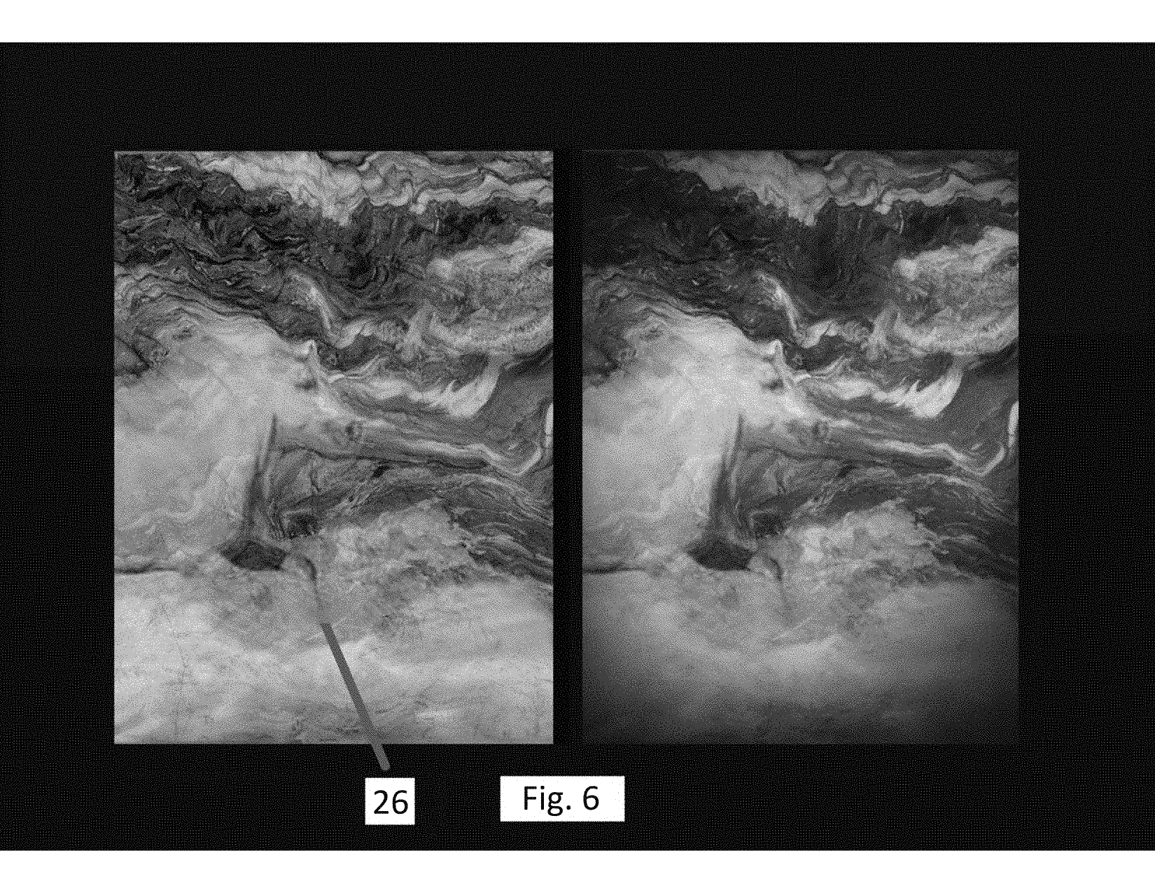

In another embodiment, as demonstrated in FIG. 6, a substantially complete copy of all visual depictions on art object 12 are captured utilizing image capture device 40 and projected using image projection device 50 onto display stone 10.

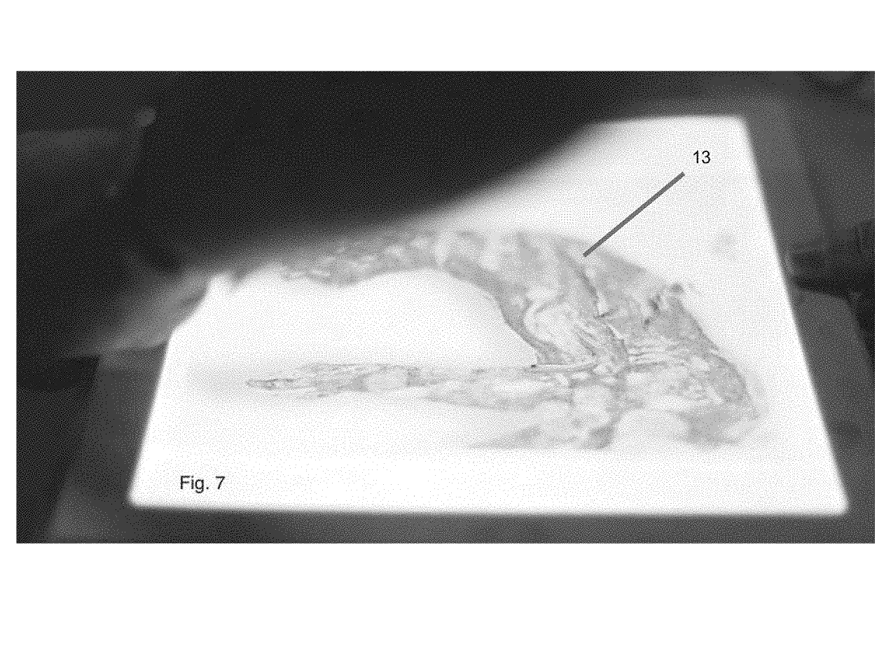

In another embodiment of the present invention, as demonstrated in FIG. 7, parallel art object 13 is captured utilizing image capture device 40 and prepared as a transparent, semitransparent, or translucent article whereby the subsequent image is projected using image projection device 50 onto display stone 10 enable a viewer's perception the previously unseen image.

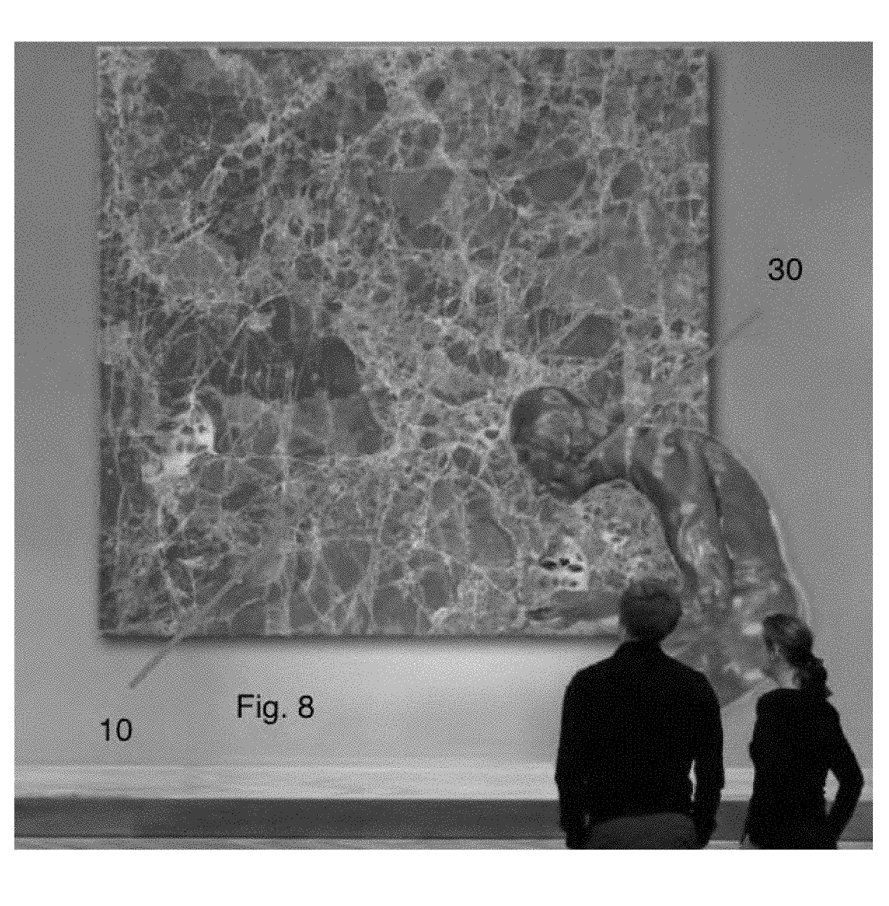

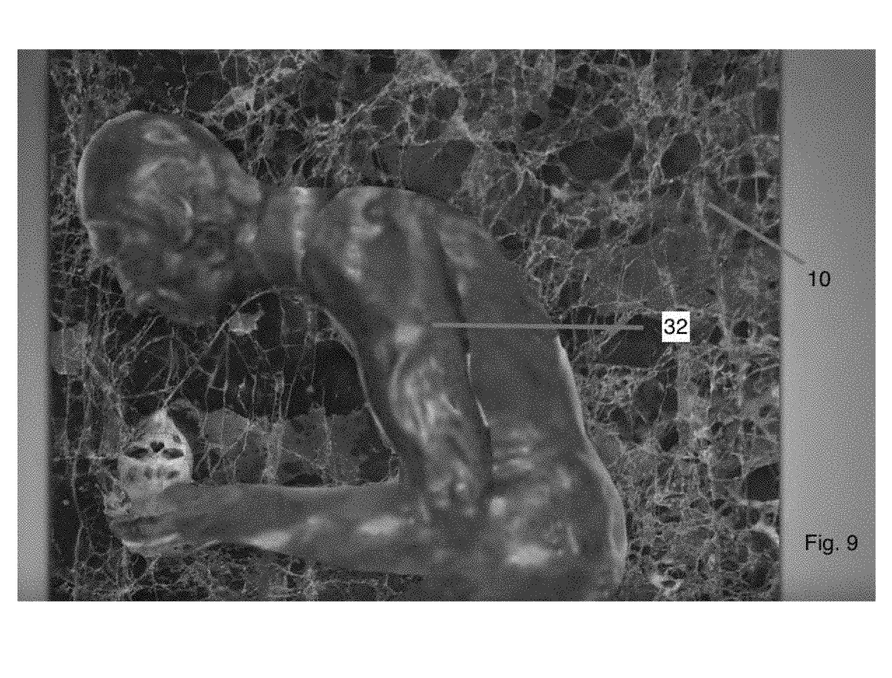

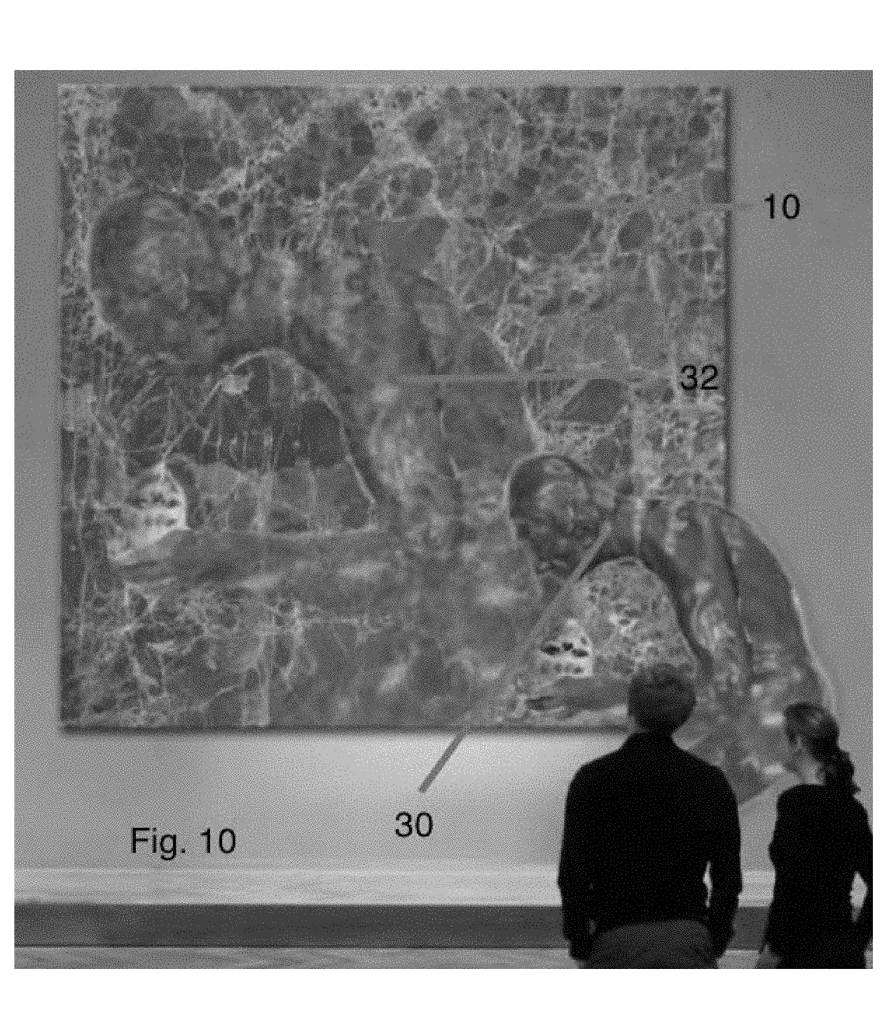

In another embodiment of the present invention, as depicted in FIGS. 8, 9, and 10, the parallel art object is a three dimensional sculpture 30 that has an image of sculpture 30 captured utilizing image capture device 40 and subsequently projected using image projection device 50 onto display stone 10.

Technology has provided that there are many components available in order to practice the present invention. For example, the image capture device is one or more camera devices operatively associated with the various components of the present invention. However, the camera device can be paired with one or more additional image capturing devices utilizing nonvisible light such as ultraviolet or infrared detectors whereby ultraviolet and infrared detectable material is used in the parallel art object. This is but one example and the present invention contemplates utilization of cameras for visual light image capture and nonvisual lights components that are captured using appropriate image capture devices.

In another embodiment, it is contemplated using display components such as lasers, LED or other targeted lighting to portray the art image on the stone display, to accomplish the same, just without using a projector.

As generally understood, the display and method of the present invention can use one or more parallel art objects, whereby their images are displayed on a single stone display.

In another embodiment, the display and method of the present invention can utilize multiple stone displays.

In one embodiment, the present invention includes an analysis of the viewing surface of the display stone to analyze various physical and topological features that are utilized along with displaying the image on the viewing surface.

In one non-limiting example, a relatively smooth surface on the viewing surface of the display stone is selected for display of a particular image or portion of an image from the parallel art object.

In utilizing the analysis of the viewing surface, the artistic creation can utilize various components and characteristics of the surface in order to enhance a particularized display.

In one embodiment, the projected image is from a file created from mapping topological features of a projection surface.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed is:

1. A visual display system comprising:
at least one stone display;
at least one parallel art object;
at least one image capture device, constructed and arranged to capture an image of said at least one parallel art object;
at least one image display device operatively associated with said image capture device whereby said image display device is constructed and arranged to display an image on said stone display.

2. The visual display system of claim 1, wherein said stone display is selected from granite, onyx wood, or other natural surface.

3. The visual display system of claim 1, wherein said stone display has a viewing surface prepared for use in said visual display.

4. The visual display system of claim 1, wherein said stone display has a viewing surface prepared for use in said visual display, said preparation optionally includes altering or forming topological features on said viewing surface.

5. The visual display system of claim 1, wherein said parallel art object is a two dimensional object.

6. The visual display system of claim 1, wherein said parallel art object is a three dimensional object.

7. The visual display system of claim 1, wherein said image capture device is a camera.

8. The visual display system of claim 1, wherein said image capture device captures non-visible light components.

9. The visual display system of claim 1, wherein said image capture device is operatively associated with a computer microprocessor constructed and arranged to capture an image from said parallel art object.

10. The visual display system of claim 1, wherein said image display device is operatively associated with said image capture device whereby said image display device is constructed and arranged to display an image onto said display stone.

11. The visual display system of claim 1, wherein said image display device is operatively associated with said image capture device whereby said image display device is constructed and arranged to display an entire image of said parallel art object onto said display stone.

12. The visual display system of claim 1, wherein said image display device is operatively associated with said image capture device whereby said image display device is constructed and arranged to display a user selected or user modified portion of an image of said parallel art object onto said display stone.

13. (canceled)

14. A visual display system comprising:
at least one display surface having topological features;
at least one image capture device, constructed and arranged to capture an image of said topological features;
at least one image display device operatively associated with said image capture device whereby said image display device is constructed and arranged to display an image on said stone display.

15. (canceled)

16. (canceled)

17. The visual display system of claim 14, wherein said display surface has a viewing surface prepared for use in said visual display, said preparation including altering or forming topological features on said viewing surface.

18. The visual display system of claim 14, wherein said image capture device is a camera.

19. (canceled)

20. The visual display system of claim 14, wherein said image capture device is operatively associated with a computer microprocessor constructed and arranged to capture an image from said display surface.

21. The visual display system of claim 14, wherein said image display device is operatively associated with said image capture device whereby said image display device is constructed and arranged to display an image onto said display stone.

22. The visual display system of claim 14, wherein said image display device is operatively associated with said image capture device whereby said image display device is constructed and arranged to display an entire image of said parallel art object onto said display stone.

23. The visual display system of claim 14, wherein said image display device is operatively associated with said image capture device whereby said image display device is constructed and arranged to display a user selected portion of an image of said parallel art object onto said display surface.

24. A method for displaying an image, said method comprising:
providing a display surface having at least one viewing surface;
providing a parallel art object;
providing an image capture device;
capturing an image from said display surface with said image capture device;
processing said captured image with a microprocessor outputting said captured image to an image display device;
projecting said output image from said image display device onto the viewing surface of the display surface.
